(19) United States
(12) Patent Application Publication
(10) Pub. No.: US 2011/0270766 A1
(43) Pub. Date: Nov. 3, 2011

(54) Internet Based Offer Routing and Workflow Engine Method

(75) Inventors: Parameswaran Ramakrishnan, Concord, CA (US); Kevin Wesley Kopp, Noblesville, IN (US); Thomas Fields, Prairieville, LA (US); William Flynt Stilley, Gonzales, LA (US)

(73) Assignee: Offer XChange, LLC.

(21) Appl. No.: 12/772,219

(22) Filed: May 2, 2010

(51) Int. Cl. G06Q 50/00; H04L 9/32; G06F 15/16; G06Q 30/00; G06Q 10/00

(52) U.S. Cl. 705/80; 709/203; 726/6

(57) ABSTRACT

A system that enables parties to a real estate transaction to remotely access the system via the internet to initiate and consummate the offer/counter-offer process leading up to and including execution of a definitive purchase agreement between buyer and seller, wherein parties to the real estate transaction include the Buyer, the Seller and their respective agents. The system provides for a user interface that enables input of the transaction specification information which is typically input by the real estate agent. Subsequently, the system enables secure routing of the transaction between the parties for their online review and response. The system also provides for unique identity verification, logging and tracking functions to ensure validity and enforceability of electronic acceptance of transactions and related purchase agreements and documents by all parties.

### FIELD OF THE INVENTION

Embodiments of the invention relate generally to the processing and routing of offers for real estate purchases between buyers, sellers and agents. More particularly, embodiments of the invention allow for input of offer information via a secure internet based browser interface, routing of the offer information between all parties participating in the transaction and tracking of responses (acceptance/dedination/counter) by all such parties via an online internet-based portal hub.

### BACKGROUND OF THE INVENTION

The traditional real estate purchase process consists of a multi-step offer/counter-offer process involving multiple parties that is both time consuming and highly manual in nature. In a typical real estate transaction, both the Seller and the Buyer normally have real estate agents that represent them and help facilitate the transaction. The Seller's Agent assists the Seller in properly listing the real estate property for sale including assessing a fair market sale price for the specific property. Additionally, the Seller's Agent also presents offers made by prospective buyers to the Seller and assists with the negotiation and closing process. On the other hand, the Buyer's Agent assists the Buyer with property selection by assessing the specific needs and desires of the Buyer and showcasing properties for sale that meet these specific needs and desires. Additionally, the Buyer's Agent also assists with drafting the proper offer/purchase agreements, presenting them to the Seller through Seller's Agent and assist with the negotiation and dosing process.

Once a Buyer has chosen a specific real estate property to initiate an offer on; the Buyer's Agent typically drafts all the purchase and disclosure Agreements and sends them to the Buyer for review and acceptance. This correspondence is typically done via fax, electronic mail, and courier or delivered in person by the Agent. After the Buyer has had the opportunity to review and accept the terms of the purchase agreement, including all the supplemental disclosure forms, the Buyer's Agent will send the purchase agreement and related documents to the Seller's Agent for presentation to the Seller. Upon receipt of the document package by the Seller's Agent and subsequent review and approval, the Seller's Agent will present the offer and related documents to the Seller for review and acceptance. In almost all situations, the Seller's Agent is required by law to present all offers made by prospective buyers to Seller for a final decision. At this point, the Seller can choose to accept the offer, decline the offer, or make a counter-offer. Each one of these actions trigger a series of corresponding steps that require additional documentation and paperwork to be filled out by the Seller's Agent, approved by the Seller and routed back to the Buyer's Agent for presentation to the Buyer. This entire process continues back and forth between the Buyer and Seller, with agents in between until both parties reach common agreement on purchase terms OR the negotiation process ends without a successful sale.

It becomes quickly apparent that the offer/counter-offer process associated with real estate transactions is a highly time consuming and labor intensive process that is strife with several manual procedures and operations causing greater margins for error. Additionally, the process is also very much dependent on paper and involves significant utilization of fax, electronic mail and courier to transport the purchase agreements and related documents between all the related parties. Even with the utilization of electronic mail, the sending party still needs to scan the completed documents and email them to the recipient. The recipient subsequently needs to print the documents, sign/complete, scan and email back to the sender. Finally, the utilization of fax gives rise to several potential compliance issues, as sensitive documents containing personal data and information are sent to public fax numbers e.g. public offices etc.

There exists software systems (both downloadable software programs and web based systems) that aid in the preparation and generation of state-specific purchase agreements and related disclosure documents wherein a sender (e.g. Agent) can complete forms that contain all the data elements to be populated on the various forms and subsequently download and access the completed populated forms in an electronic manner. However, even with the use of these systems, the sender must still either download, print and fax the documents to the recipient OR save and email the forms to the recipient who must subsequently print the documents for signature. A unified online internet based hub solution that enables electronic routing of these documents between all the parties involved in a seamless and electronic manner doesn't exist in the market.

There also exists internet based software systems that enable capture of electronic signatures on agreements and documents. Using these systems, a sender (e.g. Buyer's Agent) is able to upload documents to the online software system and indicate on which pages signatures and initials are needed by the recipient (e.g. Buyer). The recipient subsequently receives an email that contains a link to a website that enables them to sign-in, review the documents online and electronically affix initials and signatures on the relevant pages to indicate their acceptance. However at that point, if the sender (e.g. Buyer's Agent) needs to route the documents to another party (e.g. Seller's Agent), they will need to download the documents signed by the Buyer and email/fax it to the Seller's Agent. Subsequently, the Seller's

Agent would need to re-upload the documents to the system if they want to send it to the Seller for their review and acceptance. Most of these systems are agnostic to the type of transaction/industry and rely upon the sender to upload the documents that need to be reviewed and signed by the recipient. The documents could be virtually any type of agreement or form needing a signature. Finally, these systems do not contain any sort of identity verifications mechanisms or tools to verify the identity of the party who is electronically signing the agreement or form. In several instances, including real estate transactions, it is imperative that all documents signed by all parties (Buyer and Seller) meet the requirements of the Federal Electronic Signatures in Global and National Commerce (E-SIGN) Act including verifying the identities of all parties.

Although prior systems are functional and might meet some of the workflow needs of real estate transactions, there remains a strong need in the marketplace for a true internet based offer routing and workflow engine for the real estate industry. Moreover, because prior art systems are unable to provide a holistic end-to-end solution that captures all the various touch points within a traditional real estate purchase transaction, a need exists for an online internet based hub solution that brings together and connects all the parties associated with a real estate transaction in a seamless and automated manner while ensuring compliance with all state and federal laws and regulations.

### SUMMARY OF THE INVENTION

Various embodiments of the present invention provide for an internet based software solution that automates the routing of offers between parties to a real estate transaction. Additionally, the internet based software solution also provides for tracking of responses (accept/decline) of the various parties in an electronic manner. The system is accessible via the internet using a conventional web browser interface (e.g. Microsoft Internet Explorer, Mozilla FireFox, Apple Safari etc.) and/or a mobile browser based interface (e.g. Apple iPhone®, RIM Blackberry®, Microsoft Windows Mobile® based devices, etc).

In accordance with one embodiment, a method is provided comprising remote user input of data pertaining to a real estate purchase transaction via a secure internet based browser or mobile device interface. The method further comprises selection of one or more system offered purchase agreements and forms associated with the specific jurisdiction (state/city/county) that the transaction is being conducted in. Additionally, the method enables online review of the user selected agreements and forms with the relevant transaction data populated prior to routing to one or more parties to the real estate transaction.

Another embodiment of the invention, comprises of an internet based routing engine that facilitates the secure routing of transaction and related data and forms between all parties participating in the real estate transaction. Each party receives an email that contains a link to a secure website that requires them to validate their identity prior to accessing the specific transaction for their review and acceptance.

As is apparent from the above, it is an advantage of the present invention to provide methods and systems for the automation of real estate purchase transaction routing and acceptance tracking via a secure online internet based solution. Other features and advantages of the present invention will become apparent by consideration of the detailed description and accompanying drawings.

### BRIEF DESCRIPTION OF THE DRAWINGS

In the drawings:

FIG. 1 illustrates an exemplary flowchart of the current market workflow of processes related to a real estate purchase transaction involving a Buyer, a Seller and their respective real estate agents.

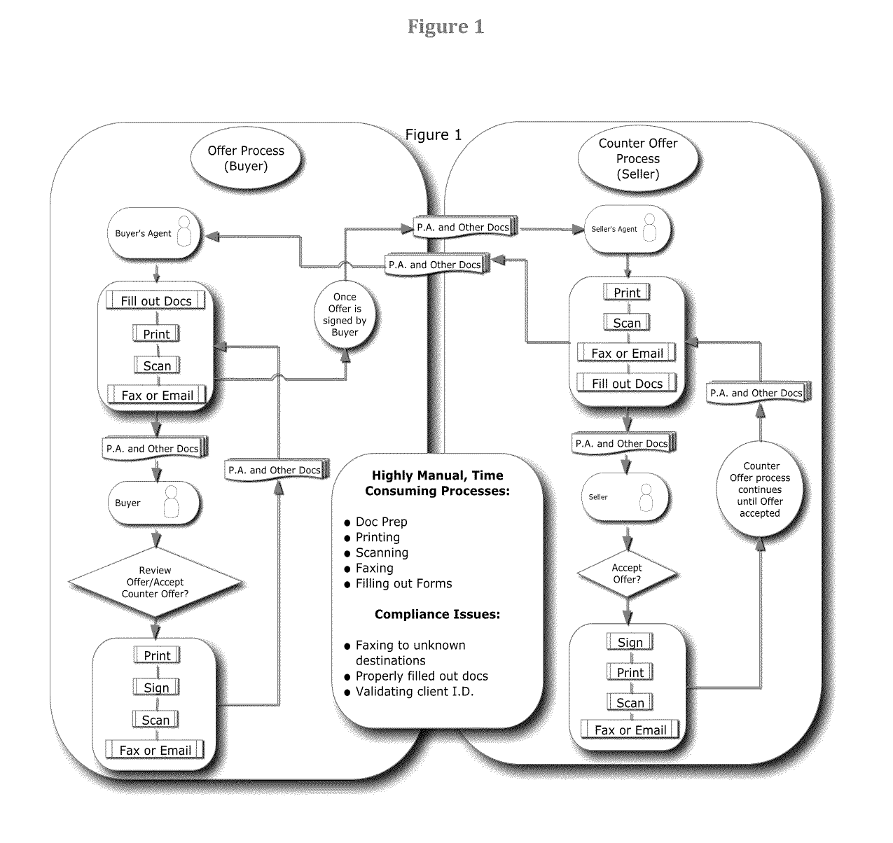

FIG. 2 illustrates an exemplary flowchart of the proposed workflow of processes related to a real estate purchase transaction involving a Buyer, a Seller and their respective real estate agents by utilizing and leveraging the present invention.

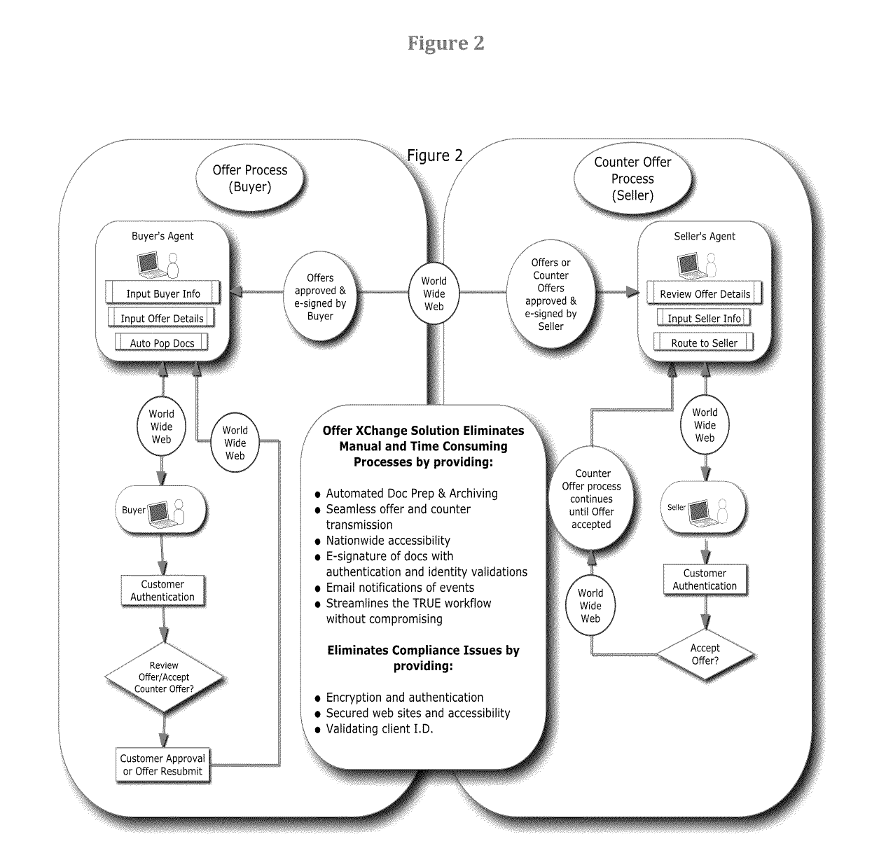

FIG. 3 illustrates an exemplary flowchart of processes performed by a Buyer's Agent utilizing the present invention to initiate a new offer to purchase a real estate property on behalf of the Buyer.

FIG. 4 illustrates an exemplary flowchart of processes & functions performed by the present invention to automatically generate user accounts with random passwords based upon personal information of the user as well as email notifications with login access instructions to automatically route offer transactions between parties.

FIG. 5 illustrates an exemplary flowchart of processes performed by a Buyer utilizing the present invention to review and approve a new offer to purchase a real estate property initiated by the Buyer's Agent.

FIG. 6 illustrates an exemplary flowchart of processes performed by a Seller's Agent utilizing the present invention to review and forward to Seller, upon receipt from Buyer's Agent, a new offer to purchase Seller's real estate property from Buyer.

FIG. 7 illustrates an exemplary flowchart of processes performed by a Seller utilizing the present invention to review and accept or decline a new offer from Buyer to purchase Seller's real estate property.

FIG. 8 illustrates an exemplary flowchart of processes performed by a Seller utilizing the present invention to counter-offer a new offer from Buyer to purchase Seller's real estate property.

FIG. 9 illustrates an exemplary flowchart of processes performed by a Seller's Agent utilizing the present invention to initiate a counter-offer to an offer initiated by a Buyer to purchase Seller's real estate property.

FIG. 10 illustrates an exemplary software system architecture diagram showing the various interfaces and components of the invention.

### DETAILED DESCRIPTION OF THE PREFERRED EMBODIMENTS

Before embodiments of the invention are explained in detail, it is to be understood that the invention is not limited in its application to the details of the construction and the arrangements of the components set forth in the following description or illustrated in the drawings. The invention is capable of still other embodiments and of being practiced or being carried out in various ways. Also, it is to be understood that the phraseology and terminology used herein is for the purpose of description and should not be regarded as limiting.

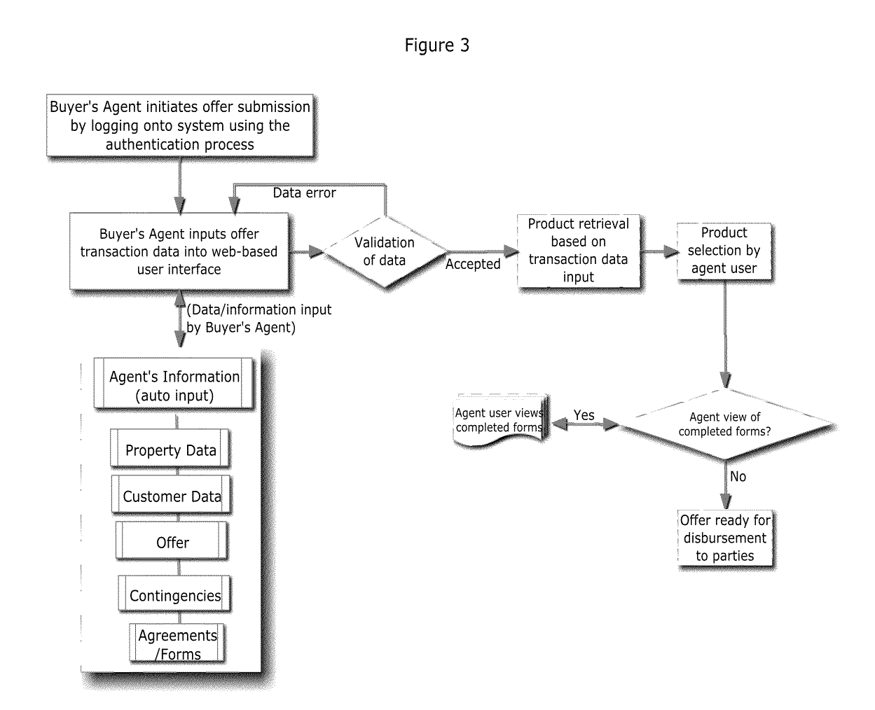

An exemplary system of one embodiment can include a web server that contains web form pages and related software code and logic that enables remote capture of information related to a real estate purchase transaction. Specifically, as outlined in FIG. 3, a real estate agent representing a Buyer can access the web server via a standard web browser interface and initiate a new transaction by inputting all the data required to create a new real estate purchase offer in the system. Upon completion of data input by the agent, the system can invoke a validation routine to ensure that all the data has been accurately filled out prior to proceeding to the next step. Subsequently, the system can retrieve a list of products based upon the jurisdiction (state/dty/county) the transaction is being conducted in and the specific products the agent user has subscribed to, and present them for user selection. Each product selection can contain a list of associated forms and documents including a purchase agreement for that jurisdiction and any related disclosure and other types of transaction specific forms. Additionally, upon selection of the product and related forms by the agent user, the system can retrieve a list of additional fields for data input by the agent user based upon the forms selected. Upon successful completion of data input by the agent user, the system can invoke another validation routine to ensure that the additional data input by the agent user is accurate and valid and subsequently present the agent user with a summary of the entire transaction with the ability to view the completed forms online via the web browser interface.

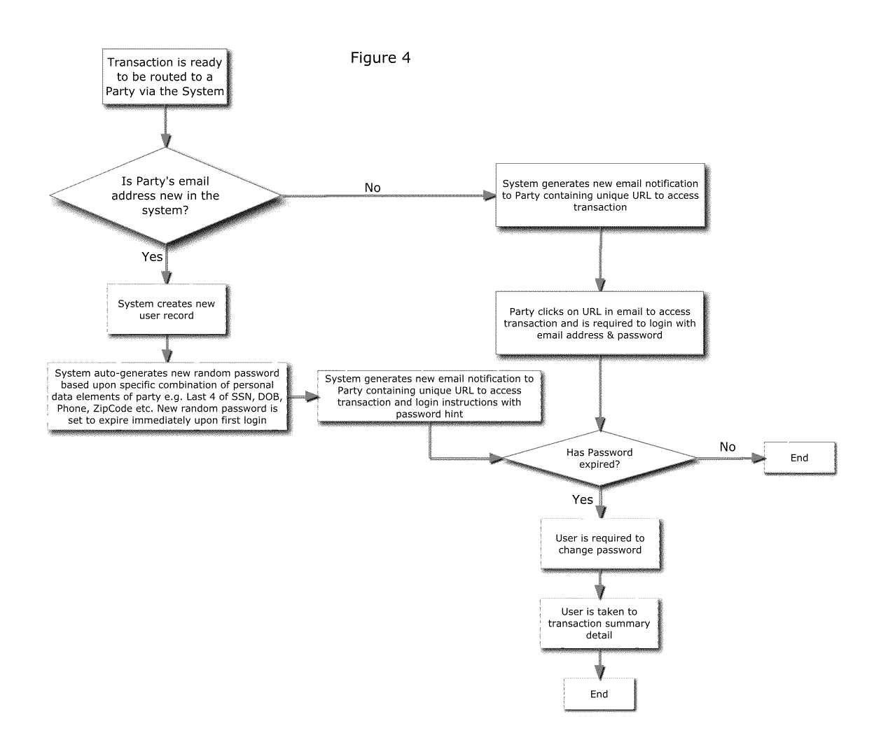

An exemplary system of yet another embodiment can include an internet based software system that enables secure routing of real estate offer transactions between all parties to the transaction for their online review and response. Specifically, as indicated above, once a Buyer's Agent has input all the transaction data into the system and chosen the specific agreements and forms related to the transaction, the agent user can have the ability to utilize the system to route the transaction to the Buyer for their review and acceptance. Upon initiation of the routing request by the agent user, as outlined in FIG. 4, the system can automatically generate an email to be sent to the Buyer's email address with a unique website URL where the Buyer can go to review the terms of the transaction and indicate their acceptance or declination. The email can also contain a temporary password that is randomly assigned by the system based upon some elements of personal information of the Buyer that only the Buyer would know e.g. date of birth+last four digits of social security number OR home phone number+date of birth etc. The email can only contain instructions on the password and never the actual password itself e.g. “Your randomly generated password is the last four digits of your SSN+your home phone number. For example, if the last four digits of your SSN is 1125 and your home phone number is 770-920-5086, then your password will be “1125+770-920-5086”. Upon receipt of the email by Buyer and invocation of the URL contained in the email, the system can require the Buyer to validate their identity by authenticating themselves with a username and password. The username can be the unique email address of the Buyer and the password can be the system generated random password contained in the email. Additionally, the system can also present the Buyer with specific questions to answer based upon public record data that only the Buyer should be able to answer. This unique authentication mechanism can meet one of the requirements of the Federal Electronic Signatures in Global and National Commerce (E-SIGN) Act which requires that electronic signature systems validate the identity of the party electronically signing agreements and be able to prove the same. Upon successful authentication, the system can force the Buyer user to change their password to the system, thus protecting the confidentiality and security of the user's account. Additionally, the system can enforce online security best practices such as enforcing strong passwords and requiring users to change their password every 60 days.

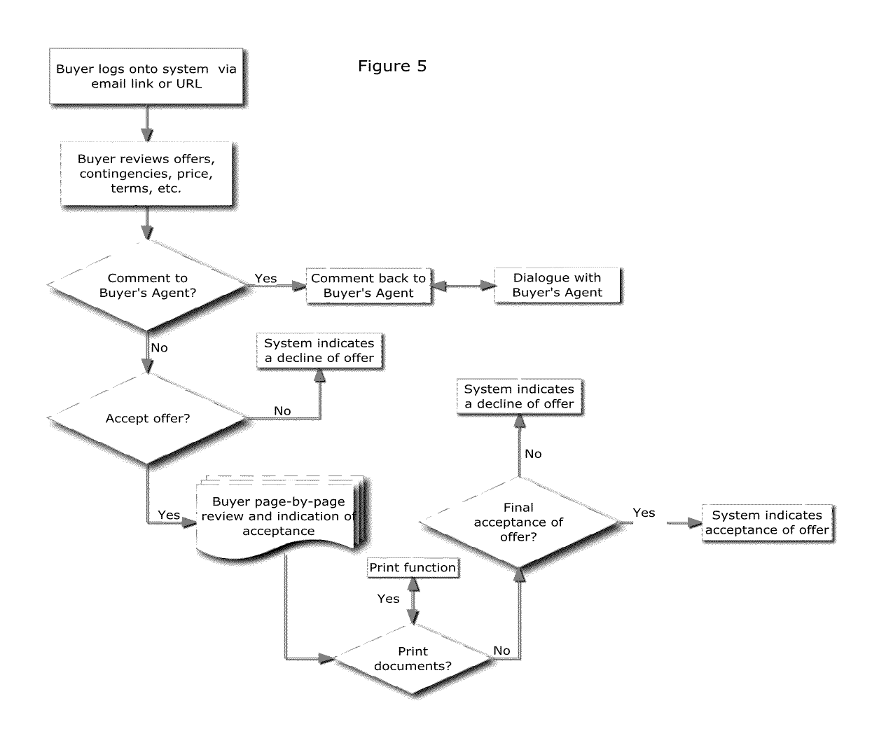

Upon successfully authenticating the identity of the Buyer, as outlined in FIG. 5, the system can present the Buyer with a summary of the terms of the transaction including the address of the real estate property, the purchase price, offer contingencies etc. Additionally, the system can present the Buyer user with several different options including: a). Utilizing the online system to send comments back to their agent; b). Commence the transaction acceptance process; c). Edit the transaction and route back to their agent; and d). Decline the transaction. Once the Buyer selects the option to commence the transaction acceptance process, the system can launch a unique page -by-page display mode of all the agreements and forms contained in the transaction. The Buyer user will be required to review each page and indicate their acceptance prior to proceeding to the next page. Upon acceptance of the terms and conditions and content of a specific page, the system can log the date, time, IP address and user-id of the Buyer user. This process can ensure compliance with logging and audit trail requirements associated with the Federal E-SIGN Act. In the event the Buyer user would like to print the documents and forms for offline reading, the system can enable a Print function that will print all the documents and forms associated with the transaction with all the relevant and required data populated. After the Buyer user has completed reviewing all pages associated with all documents contained in the transaction, the system can present the Buyer user with the ability to indicate their final acceptance to the transaction. Upon invocation of final acceptance by the Buyer user, the system can log the date, time, IP address and user-id of the Buyer user and automatically notify the Buyer's Agent via email that the Buyer has accepted the terms of the offer and that the transaction is ready to be routed to the Seller's Agent.

Upon receipt of the “Buyer Acceptance” email by the Buyer's Agent, as indicated above, the Buyer's Agent can login to the system to route the transaction to the Seller's Agent for their review and subsequent presentation to the Seller. Additionally, the Buyer's Agent can be given the option to indicate to the system to automatically route the transaction to Seller's Agent upon acceptance by Buyer. Upon initiation of the routing request to Seller's Agent, the system can automatically generate an email to be sent to the Seller's Agent's email address with a unique website URL where the Seller's Agent can go to review the terms of the transaction and forward the transaction to the Seller for their review and acceptance or dedination. The email can also contain a temporary password that is randomly assigned by the system based upon some elements of personal information of the Seller's Agent that only the Seller's Agent would know e.g. Realtor ID+phone number OR phone number+last four digits of SSN etc The email can only contain instructions on the password and never the actual password itself e.g. “Your randomly generated password is your Realtor ID+your phone number. For example, if your Realtor ID is 9648 and your phone number is 817-854-9521, then your password will be “9648+817-854-9521”. Upon receipt of the email by Seller's Agent and invocation of the URL contained in the email, the system can require the Seller's Agent to validate their identity by authenticating themselves with a username and password. Additionally, the system can also present the Seller's Agent with specific questions to answer based upon public record data that only the Seller's Agent should be able to answer

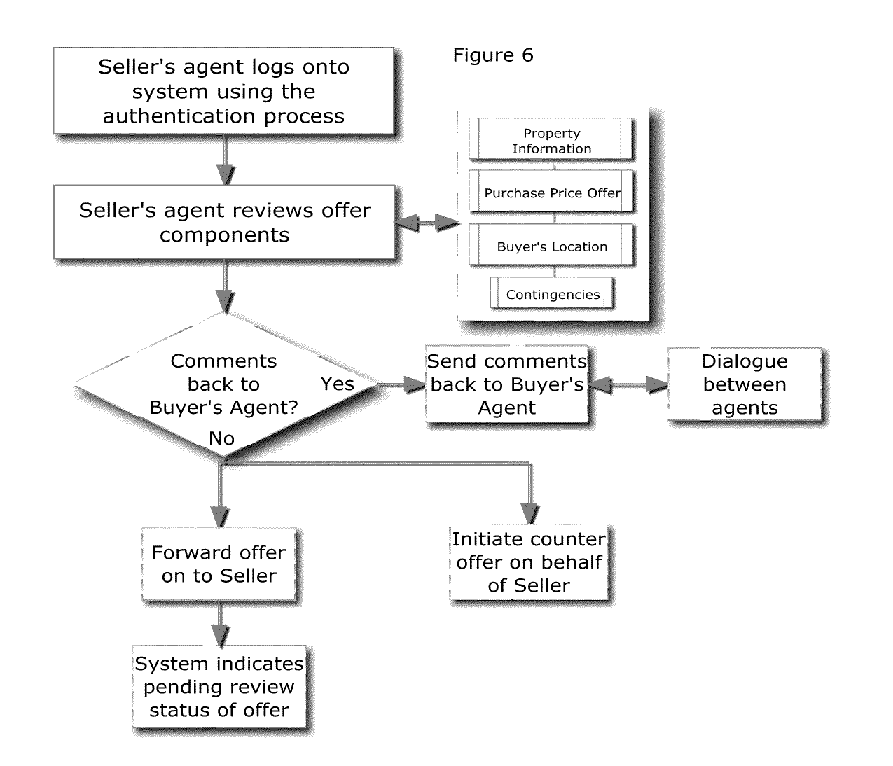

Upon successfully authenticating the identity of the Seller's Agent, as outlined in FIG. 6, the system can present the Seller's Agent with a summary of the terms of the transaction including the identity of the Buyer, the purchase price, offer contingencies etc. Additionally, the system can present the Seller's Agent with several different options including: a). Utilizing the online system to send comments back to Buyer's Agent; b). Forward the transaction to the Seller for their review and acceptance/declination; and c). Initiate a counter-offer on behalf of the Seller. Upon initiation of the routing request to Seller, the system can automatically generate an email to be sent to the Seller's email address with a unique website URL where the Seller can go to review the terms of the offer and indicate their acceptance or declination. The email can also contain a temporary password that is randomly assigned by the system based upon some elements of personal information of the Seller that only the Seller would know e.g. date of birth+last four digits of social security number OR home phone number+date of birth etc. The email can only contain instructions on the password and never the actual password itself e.g. “Your randomly generated password is the last four digits of your SSN+your home phone number. For example, if the last four digits of your SSN is 1125 and your home phone number is 770-920-5086, then your password will be “1125+770-920-5086”. Upon receipt of the email by Seller and invocation of the URL contained in the email, the system can require the Seller to validate their identity by authenticating themselves with a username and password. The username can be the unique email address of the Seller and the password can be the system generated random password contained in the email. Additionally, the system can also present the Seller with specific questions to answer based upon public record data that only the Buyer should be able to answer. This unique authentication mechanism can meet one of the requirements of the Federal Electronic Signatures in Global and National Commerce (E-SIGN) Act which requires that electronic signature systems validate the identity of the party electronically signing the agreement/document and be able to prove the same. Upon successful authentication, the system can force the Seller user to change their password to the system, thus protecting the confidentiality and security of the user's account. Additionally, the system can enforce online security best practices such as enforcing strong passwords and requiring users to change their password every 60 days.

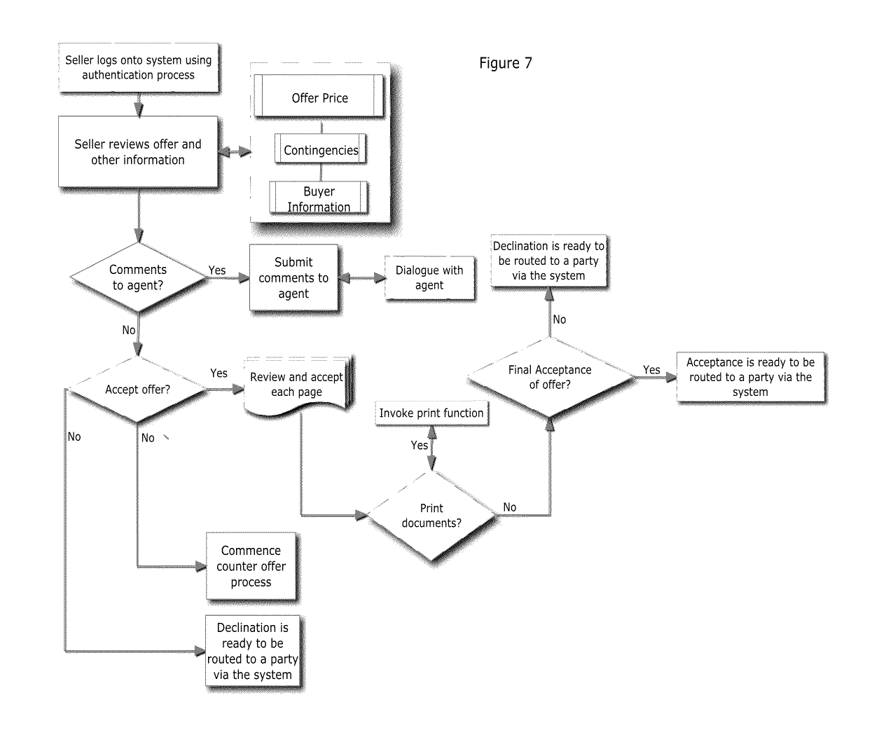

Upon successfully authenticating the identity of the Seller, as outlined in FIG. 7, the system can present the Seller with a summary of the terms of the transaction including identity of the Buyer, the purchase price, offer contingencies etc. Additionally, the system can present the Seller with several different options including: a). Utilizing the online system to send comments back to their agent; b). Commence the Offer Acceptance Process; c). Commence the Counter-Offer Process; and d). Decline the Offer. Once the Seller selects the option to commence the Offer Acceptance Process, the system can launch a unique page-by-page display mode of all the agreements and forms contained in the transaction. The Seller user will be required to review each page and indicate their acceptance prior to proceeding to the next page. Upon acceptance of the terms and conditions and content of a specific page, the system can log the date, time, IP address and user-id of the Seller. This process can ensure compliance with logging and audit trail requirements associated with the Federal E-SIGN Act. In the event the Seller user would like to print the documents and forms for offline reading, the system can enable a Print function that will print all the documents and forms associated with the transaction with all the relevant and required data populated. After the Seller user has completed reviewing all pages associated with all documents contained in the transaction, the system can present the Seller user with the ability to indicate their final acceptance to the transaction. Upon invocation of final acceptance by the Seller, the system can log the date, time, IP address and user-id of the Seller and automatically notify all parties (Buyer, Buyer's Agent, Seller, Seller's Agent) via email that the Seller has accepted the terms of the offer and that transaction has been completed.

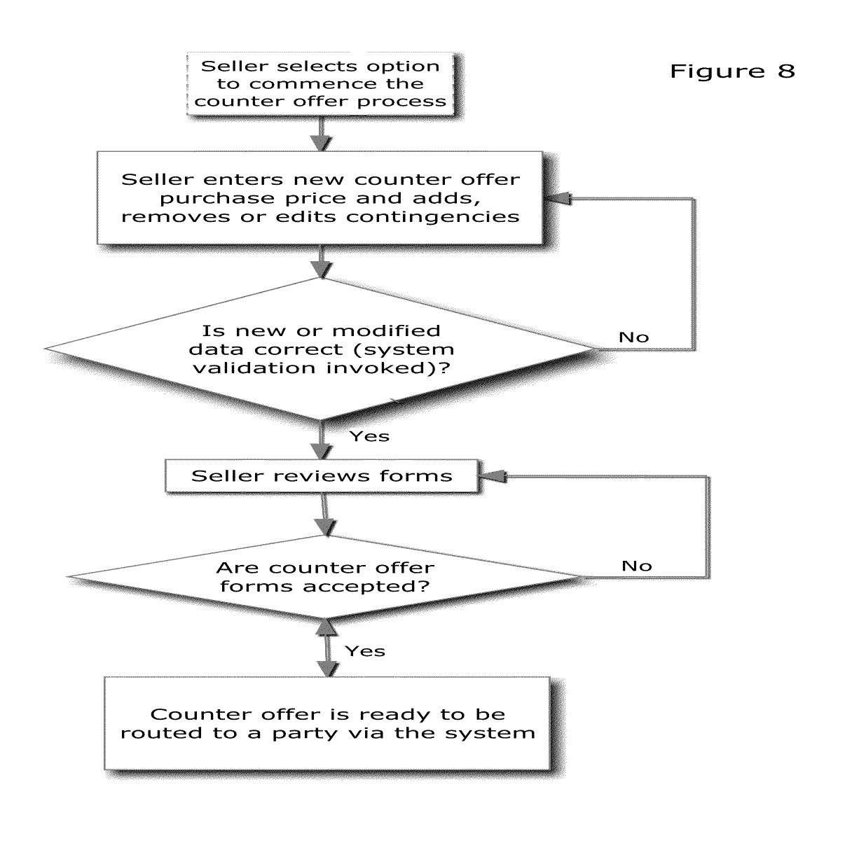

In accordance with another aspect of various embodiments, the Seller can have the ability to initiate a counter-offer to the offer initiated by the Buyer. Referring to FIG. 8, the Seller can select the option to commence the Counter-Offer Process wherein the system can present the Seller with a form that captures data related to the counter-offer including the new purchase price and any addition or removal of specific contingencies. Upon completion of data input by the Seller, the system can initiate a validation routine to ensure that all the data has been accurately filled out and completed. Subsequently, the system can display any applicable counter-offer forms to the Seller for their review and acceptance. To ensure compliance, the system can log the date, time, IP address and user-id of the Seller as each page is reviewed and accepted. After the Seller has completed reviewing all the documents and forms, the system can present the Seller with the ability to indicate their final acceptance to the counter-offer. Upon invocation of final acceptance by the Seller, the system can log the date, time, IP address and user-id of the Seller and automatically notify the Seller's Agent via email that a counter-offer has been generated for them to login and review and route to the Buyer (or Buyer's Agent).

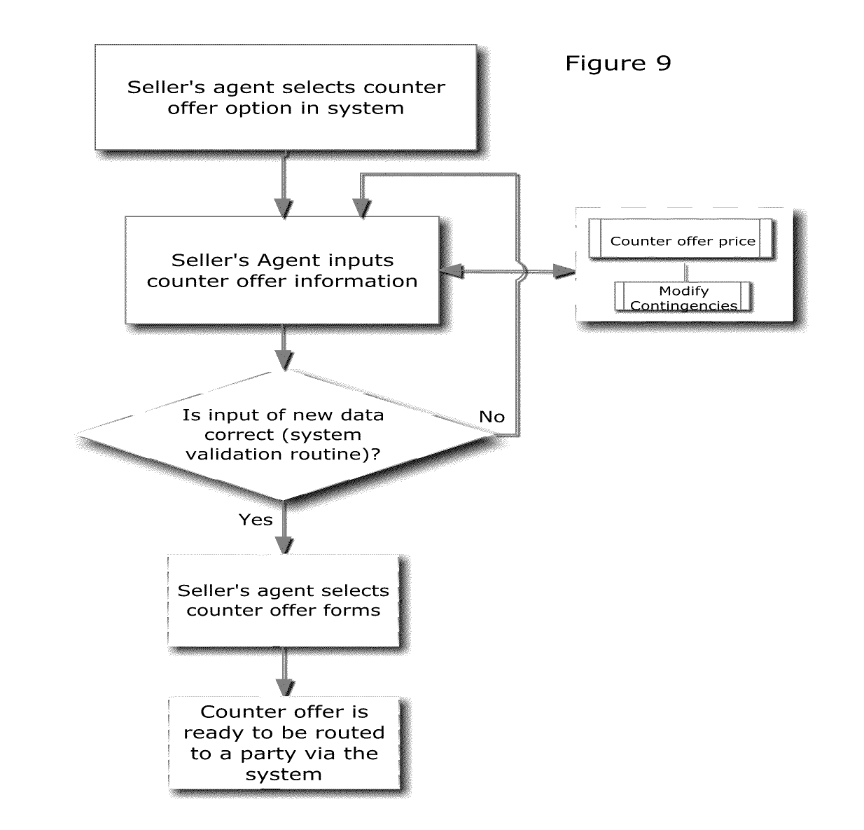

Alternatively, the Seller may request their agent to initiate a counter-offer request in the system on their behalf and route to them for final approval prior to sending back to the Buyer's Agent (or Buyer). Pursuant to FIG. 9, the Seller's Agent can initiate a counter-offer request by logging into the system and selecting the Counter-Offer option on the offer. The system can then present the Seller's Agent with a form that captures data related to the counter-offer including the new purchase price and any addition or removal of specific contingencies. Upon completion of data input by the Seller's Agent, the system can initiate a validation routine to ensure that all the data has been accurately filled out and completed. Subsequently, the system can display any applicable counter-offer forms to the Seller's Agent for their selection and inclusion in the counter-offer transaction. Once the Seller's Agent has completed all data input and forms selection activities, the system can route the counter-offer to the Seller for their final review and acceptance prior to routing back to the Buyer through Buyer's Agent. The Seller can receive an email notification notifying them to login to the system and review and accept the counter-offer request initiated by their agent.

In accordance with yet other aspects of various embodiments, the system can be configured to keep track of all activities related to a closed real estate purchase agreement including tracking the status of home inspections, termite inspections, property appraisals, lifting loan contingencies etc. Additionally, the system can be setup to generate automated notifications and alerts of all upcoming and past due activities to all parties to ensure deadlines are met in a timely manner.

In accordance with yet other aspects of various embodiments, the system can be “private labeled” for one or more realtor organizations and agencies. For example, a realtor agency can private label the system for use by their member agents by incorporating their company logo and contact information giving the agent user the perception that they are utilizing a system provided by their organization. Additionally, the system can enable a realtor agent user to “upload” and maintain their profile including one or more personal pictures. Subsequently, the system can display their profile to their Clients (Buyers, Sellers) when they login to the system to review and approve transactions.

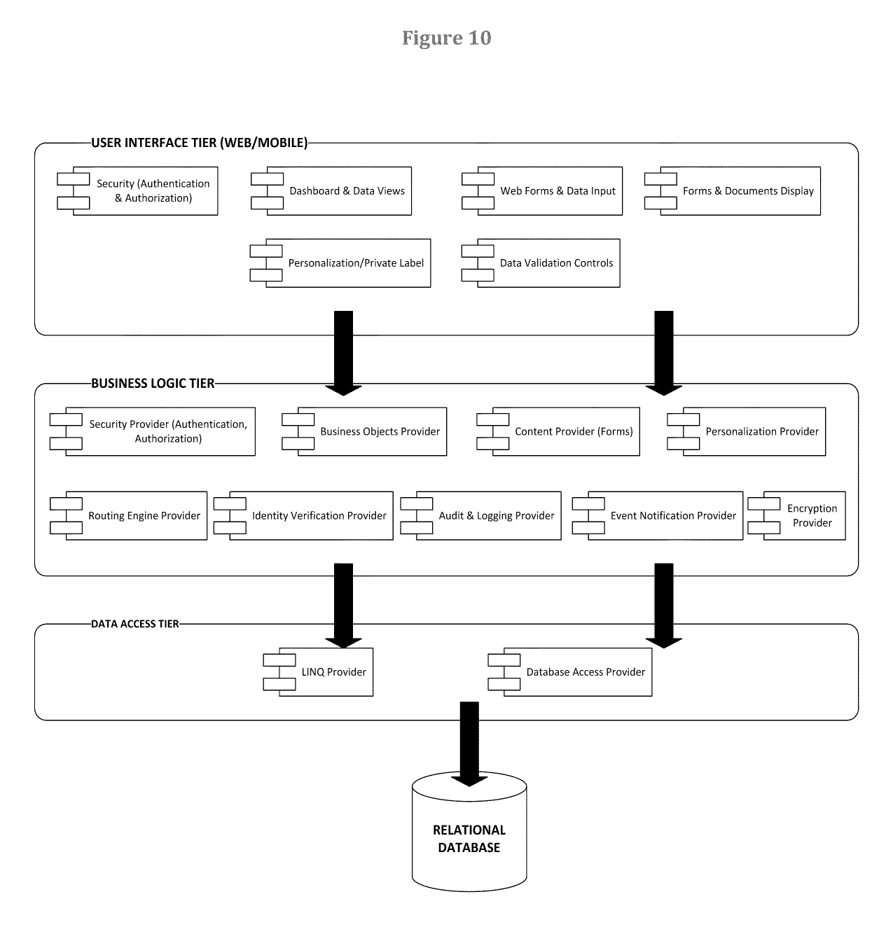

One can easily see and appreciate the numerous benefits of this invention including automating numerous transaction workflows between Buyers, Sellers and their respective agents all while ensuring the highest degree of compliance and security. As indicated in FIG. 10, the system can comprise of a User Interface Tier that consists of various pages and controls that perform different functions within the user interface including security related functions such as user login authentication & role based authorization, dashboard data display view controls, web forms for user data input, data validation controls, personalization and private label controls and document display controls. The various pages and controls of the User Interface Tier invoke subroutines and methods contained within a variety of providers in the Business Logic Tier that perform a variety of routines and functions. These include a Security Provider that performs user authentication and role retrieval and authorization functions, a Business Objects Provider that retrieves data from the relational database within business objects, a Personalization Provider that retrieves metadata and configuration information to offer personalization and private label functionality on the user interface, a Content Provider that retrieves a list of agreements, forms, documents and associated page-by-content from the relational database based upon the specific transaction, a Routing Engine Provider that enables routing of transactions between the various parties to a transaction, an Identity Verification Provider that can provide identity verification functions to verify the identities of the various parties to a transaction, an Audit & Logging Provider that provides auditing & logging functions of all access to the system by users including offer acceptance tracking and logging, an Event Notification Provider that is capable of generating notifications based upon events and user notification preferences e.g. email and an Encryption Provider that provides encryption routines to encrypt sensitive data for security purposes. Finally, the Business Logic Tier accesses a relational database that stores and maintains all the data required by the system including user security data, transaction data, product and forms data, audit & logging data and other types of configuration metadata needed by the system to perform its functions. The Business Logic Tier accesses the relational database via a Data Access Tier that consists of application programming interfaces and subroutines that query and access data from relational database.

Although only a few exemplary embodiments of this invention has been described in detail above, those skilled in the art will readily appreciate that many modifications are possible in the exemplary embodiments without materially departing from the novel teachings and advantages of this invention. As an example, this invention can also be easily adapted to facilitate routing and acceptance tracking of any type of legal transaction that requires agreements and forms to be routed between two or more parties for their review and acceptance. Accordingly, all such modifications are intended to be included within the scope of this invention as defined in the following claims.

1. A computer-implemented method that facilitates the secure routing of automated offers between Parties (herein referred to as the Buyer's Agent, Seller's Agent, Buyer(s) and Seller(s)) to a real estate purchase transaction via a centralized internet-based hub network, the transaction having a plurality of stages, the method comprising:
a. Facilitating via the centralized internet-based hub network, secured routing between all the Parties of all necessary electronic purchase offer documentation via the network.
b. Facilitating via the centralized internet-based hub network, a Buyer's Agent, initiating a new offer transaction on behalf of the Buyer by inputting offer-relevant and required information into the network and subsequent secure routing via the network of pre-populated purchase agreements and other offer documents to Buyer for review and acceptance.
c. Facilitating via the centralized internet-based hub network, the ability for Buyer to review the terms of the purchase offer generated by Buyer's Agent and indicate acceptance/declination of the transaction for subsequent secure routing via the network to Seller's Agent;
d. Facilitating via the centralized internet-based hub network, subsequent routing of Buyer-approved offer to Seller's Agent, for review and subsequent secure routing via the network to the Seller;
e. Facilitating via the centralized internet-based hub network, the ability for Seller's Agent to review the purchase offer terms generated by Buyer's Agent and accepted by Buyer, and input offer-relevant and required information into the network and subsequently route via the network to Seller for final acceptance/counter-offer/declination;
f. Facilitating via the centralized internet-based hub network, the ability for Seller to review the terms of the purchase offer generated by Buyer's Agent and subsequently accepted by Buyer and reviewed by Seller's Agent and indicate final acceptance/declination/counter-offer.
g. Facilitating via the centralized internet-based hub network, the ability for buyer's and seller's real estate agents to create, populate, and provide secure online access to all documents necessary to consummate the offer and acceptance process.
h. Facilitating via the centralized internet-based hub network, the ability for all Parties to the agreement to electronically initial and sign all required documents in compliance with Federal Electronic Signatures in Global and National Commerce Act. Facilitating via the centralized internet-based hub network, the tracking of various activities associated with real estate purchase agreements including status, deadline dates and comments, and the generation of reminder notifications pertaining to deadlines of these activities to all Parties to the transaction, including Buyer, Buyer's Agent, Seller and Seller's Agent.
i. Facilitating via the centralized internet-based hub network, a computer-implemented auditing and tracking system that implements and provides detailed audit logging and tracking mechanisms for all activities performed by users of the solution including but not limited to auditing and tracking user client internet protocol (IP) addresses, date/time of activity/action performed (e.g. user login, transaction acceptance, agreement acceptance, transaction edit etc.), user-id of user performing activity/action for the purposes of ensuring that a specific offer transaction reviewed and accepted by all Parties electronically using the solution is legally binding and enforceable and meets the requirements of the Federal Electronic Signatures in Global and National Commerce (E-SIGN) Act or any other legislation pertaining or related to and governing such transactions.

2. (canceled)

3. The method of claim 1, wherein the computer-implemented internet-based solution enables realty organizations and their realtor users to “private label” and “personalize” the solution as follows:
a. Enable realty organizations to upload and configure their company information including name, logo, address and contact information as well as colors and look and feel.
b. Enable agent users with the ability to “personalize” the user experience for their customers (buyers and sellers) by enabling them to upload their agent profile including a picture and contact information including name, company, address, phone number, email address etc. to be displayed to their customers when they access the solution.

4. (canceled)

5. (canceled)

6. The method of claim 1, wherein the Buyer or Seller's agent has the ability to select one or more agreements/forms and tag them for presentation to one or more Parties and also have the ability to upload trailing documents (i.e. copy of deposit check) as necessary for inclusion in an existing set of purchase offer documents for presentation to one or more Parties.

7. (canceled)

8. (canceled)

9. (canceled)

10. The method of claim 1, wherein the computer-implemented solution allows a page by page, automated review by each Party of every document associated with each offer and to electronically respond by electronically accepting the offer, declining the offer and/or initiating a counter-offer (Buyer or Seller agent only) as well as enabling accompanying comments to be sent by each Party along with the electronic decision.

11. (canceled)

12. The method of claim 10, wherein the computer-implemented solution facilitates the secure routing of counter-offers between Parties to a real estate purchase transaction via a centralized internet-based hub network, the transaction having a plurality of stages, the method comprising:
Facilitating via the centralized internet-based hub network, a realtor agent representing a Buyer or Seller, to input alternative offer terms including purchase price and/or any specific contingencies;
Facilitating via the centralized internet-based hub network, a realtor agent representing a Buyer or Seller, to generate applicable counter-offer agreements and forms with appropriate tracking of the number of offers and counter-offers that has transpired between the Parties;
Facilitating via the centralized internet-based hub network, a realtor agent representing a Buyer or Seller, to securely route the counter offer and associated documents to the various Parties involved in the transaction including Buyer, Seller, Buyer's Agent, Seller's Agent for their subsequent review and acceptance/declination/counter-offer.
Facilitating via the centralized internet-based hub network, the ability for a realtor agent representing a Buyer or Seller to “clone” a purchase offer or replicate an existing purchase offer and modify the purchase offer for subsequent secure routing via the network to any of the Parties.

13. (canceled)

14. (canceled)

15. (canceled)

16. (canceled)

17. A computer program implemented method that facilitates the routing of agreements and forms related to a real estate property listing transaction between Seller and a realtor agent representing Seller (Seller's Agent) via a centralized internet-based hub network, the transaction having a plurality of stages, the method comprising:
a. Facilitating via the centralized internet-based hub network, Seller's Agent initiating a new property listing transaction on behalf of the Seller and subsequent routing of the transaction to Seller for review and acceptance;
b. Facilitating via the centralized internet-based hub network, the ability for Seller's Agent to select an appropriate product package representing a specific type of real estate e.g. residential, commercial etc.) for a specific jurisdiction (e.g. state, county) and select associated agreements and forms including a listing agreement for user selection that are hosted, maintained and update by the solution provider as well as the ability to upload custom agreements and forms for inclusion in the transaction for presentation to one or more Parties.
c. Facilitating via the centralized internet-based hub network, the ability to route the new property listing transaction with associated agreements and forms to Seller for review and acceptance;
d. Facilitating via the centralized internet-based hub network, the ability for Seller to review the terms of the property listing transaction generated by Seller's Agent to indicate final acceptance or declination.
e. Facilitating via the centralized internet-based hub network, the page-by-page presentation and acceptance/declination tracking of various legal agreements and forms including listing agreements related to the property listing transaction by all required Parties including Seller and Seller's Agent.

18. The method of claim 17, wherein the centralized internet-based hub network enables realty organizations and their realtor users to “private label” and “personalize” the solution as follows:
a. Enable realty organizations to upload and configure their company information including name, logo, address and contact information as well as colors and look and feel.
b. Enable agent users with the ability to “personalize” the user experience for their seller customers by enabling them to upload their agent profile including a picture and contact information including name, company, address, phone number, email address etc. to be displayed to their customers when they access the solution.

19. (canceled)

20. (canceled)

21. The method of claim 1, wherein the centralized internet-based hub network enforces applicable user authentication, identification and security controls for each Party to the transaction that is electronically signing applicable purchase agreements and associated legal documents to ensure compliance with user identity requirements of the Federal Electronic Signatures in Global and National Commerce Act or any other legislation pertaining or related to and governing such transactions.

22. The method of claim 10, wherein the centralized internet-based hub network implements digital watermark stamping of all documents (see Reference A below as an example watermark stamped electronic document) electronically reviewed and executed by each Party to the transaction with the date, time, party name, internet protocol (IP) addresses and/or any other evidence of document execution and the electronic storage of each version of the executed document as reviewed and executed by each party sequentially.

[symbol]

23. The method of claim 10, wherein the computer-implemented solution implements functionality that enables and allows all Parties to view electronically watermark stamped documents via electronic document archiving following sequential execution of the electronic documents by the Parties.
